(19) United States
(12) Patent Application Publication
(10) Pub. No.: US 2012/0125541 A1
(43) Pub. Date: May 24, 2012

(54) Device Used For Easy Removal Of Labels From Containers

(76) Inventor: Stephen Samuel Nazarian, Penfield, NY (US)

(21) Appl. No.: 13/299,305

(22) Filed: Nov. 17, 2011

Related U.S. Application Data
(60) Provisional application No. 61/414,992, filed on Nov. 18, 2010.

(51) Int. Cl. B32B 38/10

(52) U.S. Cl. 156/750

(57) ABSTRACT

The invention described herein offers a simple, safe, elegant and effective method for the removal of labels from containers. Furthermore, for consumers who are interested in maximizing the effectiveness of their recycling effort, paper labels must be separated from metal cans before submitting for recycling. This device facilitates that removal in a safe and effective manner.

### CROSS REFERENCE TO RELATED APPLICATIONS

This application claims priority to U.S. Provisional Application entitled “Device Used For Easy Removal Of Labels From Containers” #61/414,992 filed on 18 Nov. 2010, the entire text and drawings of which are incorporated herein.

### BACKGROUND OF THE INVENTION

The present invention relates to a Device Used For Easy Removal Of Labels From Containers.

Modern product design, manufacturing and promotion has created a need for a simple but effective method for removal of labels from their containers. With recycling having become a common practice in modern society, a need has developed to facilitate the separation different materials before submitting for recycling. Given the example of a metal can . . . it is constructed of a metal cylinder that is wrapped in a paper label. Both the can and label are recyclable, however by leaving the label on the can, the majority of recycling programs do not remove the label from the can, resulting in the paper being destroyed in the process of reclaiming the metal or other material of which the container is constructed.

Effective removal of the label would allow for the paper to be recycled. In 2010, this volume of paper was in excess of 121 Million pounds. Because this paper is not being recycled, approximately 1 Million trees are cut down to create the label paper that could otherwise be created from the recycled material.

It is clearly preferable to recycle this paper instead of destroying it, but since paper labels are generally considered difficult to remove, the task is rarely accomplished.

Additionally, within some product categories, there exist label redemption programs that offer incentives to groups who can effectively collect large volumes of container labels. Although seemingly simple, these programs are predicated on the idea that the container labels are easily removed, they generally are not.

Published U.S. Pat. No. 5,289,978 of Lynn C. Lundquist describes an “APPARATUS FOR CONTINUOUS CONTAINER LABEL REMOVAL,” through the following: “This apparatus provides a mechanism for continuously removing labels and similar contaminants from granulated material prior to its reclamation into a manufactured product. Primarily, the apparatus is used to remove adhesive backed product labels from granulated plastic containers prior to their reprocessing into plastic pellets. The need for this process is particularly acute with blow-molded plastic containers which have paper and plastic labels affixed to large areas of their surface.” The need for the process described is eliminated by the invention described herein since the label would be effectively separated before entering the recycling stream.

Published U.S. Pat. No. 5,679,210 of Robert Thomas discloses and claims a “LABEL REMOVAL APPARATUS.” The patent continues to describe that “The present invention relates to a hand held label removal apparatus which provides a safe, reliable means for removing labels and safety seals from containers.” Although effectively seeking the same functional result as the invention described herein, it goes on to describe a device of some complexity. “A trigger actuated needle like cutter is manually exposed to penetrate the surface of a label and thereby remove it from the surface of a container. In addition, the cutter may be used to remove foil seals and plastic packaging found on many consumer packaging.” This complexity, though initially functional will inevitably fail due the number of interactive and codependent elements. Furthermore the safety of the invention is questionable since in its description, “Also, when the label cutter is not in use, the cutter automatically retracts, thereby, preventing accidental harm to a person.” the patent acknowledges that accidental harm to a person is possible in some state of the invention.

### SUMMARY

In response to the need to separate labels from the containers to which they are attached for the purpose of more effective recycling, the invention described herein offers a simple, safe, elegant and effective method for the removal of labels from containers. The prior art suggests and supports the need for the function of the invention, but makes no reference to the magnitude of the environmental impact should a successful device be adopted by the populace.

At first glance the device resembles a letter opener, but is in fact substantially different. Comprised of a long, pointed, non-sharp, blade extending from a handle, the device is simply inserted between the label to be removed and the container to which it is affixed. Once in position, a simple twisting action causes the integrity of the label to fail, effectively releasing it from the container. Every shape, dimension and feature of the device has been measured, tested and refined to serve the purpose of safe effective, label removal.

The main elements of the invention include: an insertion point, a blade, a handle, and a cover. There has thus been outlined, rather broadly, some of the features of the invention in order that the detailed description thereof may be better understood, and in order that the present contribution to the art may be better appreciated.

### DESCRIPTION OF THE VIEWS OF THE INVENTION

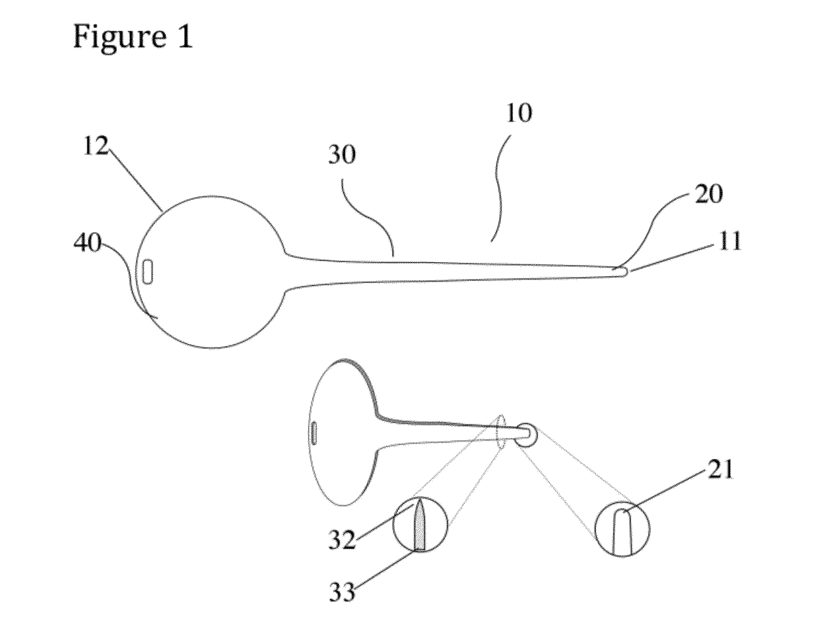

FIG. 1 is a side and ¾ view of the present invention 10.

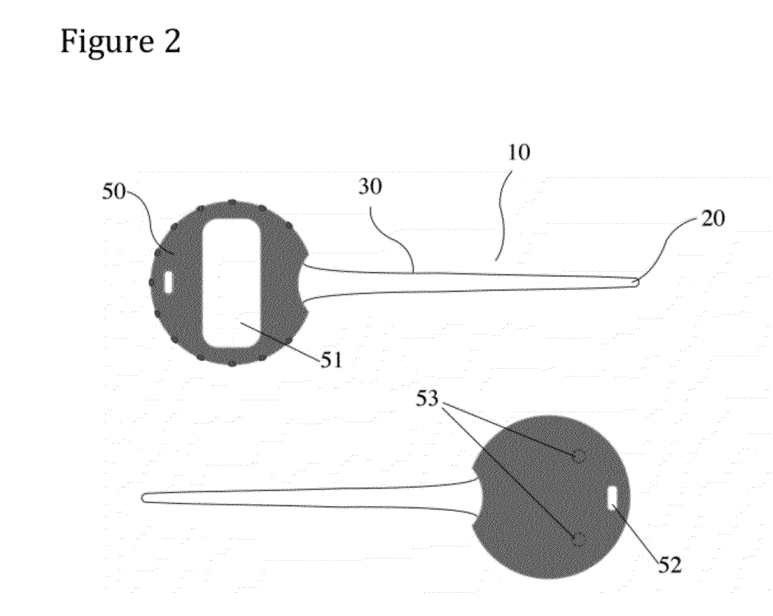

FIG. 2: FIG. 2 is comprised of two additional, opposite side views of the invention 10.

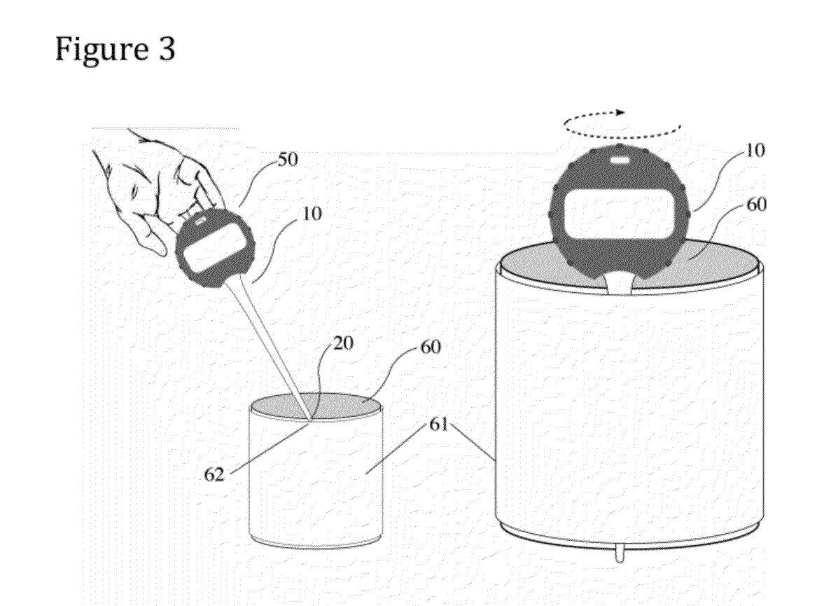

FIG. 3, illustrates how the invention is operated.

### DETAILED DESCRIPTION

Although apparently simple, the device is elegant in the effectiveness borne from that simplicity. The device provides the same end result as the prior art intended, but does so more effectively, with fewer parts and no material safety risks.

FIG. 1 is a side and ¾ view of the present invention 10. The insertion point of the device 20 is shaped such that the blade can be slid behind the label to be removed from the container. The insertion point can be made from any suitably strong and shapeable material. The shape may be as depicted in FIG. 1, or it may take on a different shape to better facilitate function. Any and all features of the invention may be coated, polished or otherwise treated to better facilitate function.

The blade 30, is shaped so that after it is inserted behind the label and turned, it will begin and then complete a cutting of the label. The blade is narrowest at the insertion point 20. It gets wider as it approaches the handle

The blade may have one tapered side 32 and one squared off side 33. The shape may be as depicted in FIG. 1, or it may take on a different shape to better facilitate function. The blade may be coated, polished or otherwise treated to better facilitate function.

The handle 40 provides the user with the leverage to turn the blade 30 and actuate the cutting of the label. The handle also provides a foundation to which the cover (FIG. 2, 50) can be attached. The handle 40 resides at the widest end of the blade 30 and provides a place for the user to hold and operate the device.

FIG. 2: FIG. 2 is comprised of two additional, opposite side views of the invention 10. The Cover 50 adds an improved feel to the handle, making it easier to hold and turn during use. The handle may contain magnets 53 that facilitate storage of the invention on a ferrous metal surface such as a refrigerator door. Additionally, the cover 50 may contain a hole 52 that facilitates storage of the invention on a hook or nail. The cover 50 may also provide a window 51 through which any markings on the handle 40 can be viewed.

The blade and its attached handle are both necessary. The blade for the cutting action and the handle for the leverage. The cover, magnets and hang hole are optional, but substantially add to the invention's appeal.

In FIG. 1 the insertion point 20 is comprised of tapered and a rounded profiles 21 that are oriented perpendicular to each other. The Blade 30 is attached to the insertion point 20 at one end 11 and the handle 40 at the other end 12. At the insertion point 20 end, the blade 30 is thinner and it graduates along its length as it approaches the other end 12 where it is attached to the handle 40. Along its length, one side of the blade 30 may have a squared off profile 33 while the other side may have a tapered profile 32. The handle 40 is attached to the blade 30 and provides mechanical leverage necessary for device operation. The handle 40 also provides a surface for any desired marking.

As illustrated in FIG. 2, the handle is shaped to accommodate the cover 50. The cover 50 is attached to the handle 40 and contains any number of physical attributes that provide grip to the user. It may contain a window 51 for viewing any marking on the handle 40. It also may contain attachment points including a hang hole 52 or magnets 53.

The invention may be made of a singular material or a combination of materials. It may also be made using suitable material not available at the time of its invention. It may be produced in a variety of sizes, while maintaining the same basic functionality. It may be produced in any number of colors or finishes or contain additional, non-functional, decorative elements.

As illustrated in FIG. 3, the invention is operated in the following manner. The user identifies a label 61 on a container 60 that they wish to remove.

The invention 10 is picked up by the cover 50. The user locates a point 62 on the label 61 where the label is not glued to the surface of the container. The user orients the invention 10 such that the insertion point 20 can be placed under the edge of the label to be removed. The user then slides the insertion point 20 and the attached blade 30 along the inside of the label 61 and along the surface of the container 60. While being inserted, the blade 30 of the device 10 should be kept flat to the surface of the container 60. Once inserted completely, the handle 40 of the device 10 is rotated in a manner such that the one side of the blade remains against the surface of the container. In doing this, the opposite edge of the blade is raised up and into the label to be removed. As the rotation of the device is completed the rising side of the blade will tear the label in part or in whole. Once the tear is complete, the device can be set aside and the user can the complete the label removal by separating the now free label from the container at any point where it may be still attached.

The invention is made with some or all the following steps:

The blade/handle shape is formed out of a suitably strong material. This forming may be a single or mufti-step process as necessary based on the material chosen. If necessary the blade/handle shapes are further enhanced by the addition of the cover. Additional steps may involve the attaching of the magnets and decorative markings in the window area of the cover.

At present the device has a singular function, however based on its similarity to a letter opener, albeit in a smaller form factor, the device could be used in place of a letter opener.

As described above, one simply slides the blade of the invention behind the label to be removed and twists. The label integrity fails under the mechanical pressure exerted by the device and is thus removed.

This device provides a purpose specific, yet straightforward approach to non-destructive removal of labels from containers. All other devices that might seek to achieve the same goal, do so either much less effectively or with far greater complexity.

1. A device used for easy removal of labels from containers.

2. A device used for safe removal of labels from containers.
